(19) United States
(12) Patent Application Publication
(10) Pub. No.: US 2022/0161995 A1
(43) Pub. Date: May 26, 2022

(54) TRASH BAG FITTING DEVICE, TRASH BAG DETECTION DEVICE, SMART TRASH RECEPTACLE AND METHOD FOR CONTROL OF AUTOMATIC BAG REPLACEMENT

(71) Applicant: SHANGHAI TOWNEW INTELLIGENT TECHNOLOGY CO., LTD., Shanghai (CN)

(72) Inventors: Jianxiang LI, Shanghai (CN); Le LI, Shanghai (CN); Beijing QIU, Shanghai (CN)

(73) Assignee: SHANGHAI TOWNEW INTELLIGENT TECHNOLOGY CO., LTD., Shanghai (CN)

(21) Appl. No.: 16/770,953

(22) PCT Filed: Jul. 20, 2019
(86) PCT No.: PCT/CN2019/096927

§ 371 Date: Jun. 9, 2020

(51) Int. Cl. B65F 1/06

(52) U.S. Cl. CPC B65F 1/062; B65F 2210/179; B65F 2210/168; B65F 1/065

(57) ABSTRACT

The present invention discloses a trash bag fitting device, including a vacuum assembly and a motor for driving the vacuum assembly. The vacuum assembly includes an air inlet and an air outlet. The air inlet communicates with the inside of the main body, with the air outlet in communication with the outside of the main body of the trash receptacle. With the combination of the weakness-free trash bag, problems of non-automatic or complex bag fitting and inconvenience of use witnessed in conventional smart trash receptacles can be overcome. The present invention discloses a smart trash receptacle incorporating the trash bag fitting device. The smart trash receptacle includes a trash bag detection device, including a transmitter for transmitting a signal and a receiver for receiving a signal, the signal received by the receiver is a direct signal transmitted from the transmitter or a signal from the transmitter that is reflected.

### BACKGROUND OF THE INVENTION

### Technical Field

The present invention relates to the field of smart trash receptacles and, in particular, to a trash bag fitting device, a trash bag detection device, a smart trash receptacle and a method for control of automatic bag replacement.

### Description of Related Art

With the advancement of technology and the improvement of people's living standards, smart homes are increasingly becoming an indispensable part of our lives. At present, smart trash receptacles have been a focus of people's attention thanks to their characteristics of cleanliness, sanitariness and convenience of use.

While trash receptacles prevalent on the contemporary market are typically capable of sensing human signals and automatically opening, they cannot automatically fit a new trash bag in place by themselves. After a full trash bag is removed, manual intervention is still required for fetching a new trash bag and fitting it into the trash receptacle (i.e. trash bag replacement by manual). Although some trash receptacles are equipped with trash bag storage means at the bottom or outside, which can save the trouble of fetching a trash bag, this could not really address the need for manual bag fitting. There are also some trash receptacles operating in a semi-automatic mechanical manner, in which an adhesive substance is applied on an outer side of a linking bar for opening a new trash bag to a certain extent at an open top of the trash receptacle. Despite some degree of semi-automation in the bag opening operation, this approach still relies on human intervention for further pulling out the new trash bag as well as for a series of additional actions for fully opening the bag to line it over the interior surface of the trash receptacle. As the bag opening operation accomplished by human intervention is inconsistent, and also since the approach itself is susceptible to degraded adhesiveness of the adhesive substance, high bag fitting quality could not be obtained.

Besides, a conventional smart trash receptacle usually includes a main body and a dump cover. Usually an infrared (IR) sensing device is arranged in the vicinity of the dump cover. The IR sensing device can cause the dump cover to be opened when sensing an approaching user and closed after the user has left. Although this can save the step for manually opening/closing the dump cover, such a simple function lags far behind users' expectations. Therefore, research efforts in the art have been placed on developing the capabilities including intelligent sensing, automatic bagging and automatic bag replacement. Among these, automatic bag replacement can dispense with manual bag replacement that consumes much time and labor. However, most smart trash receptacles currently available in the marketplace only allow manual or semi-automatic bag replacement and do not have a device capable of effectively detecting the position of a trash bag within the receptacle. For this reason, it is impossible to determine whether the trash bag has been fully fitted in place so as to prevent partial breakage of the trash bag during its automatic replacement or even potentially other safety issues of the smart trash receptacle. This limits further development of intelligence in such smart trash receptacles.

Therefore, how to address the issue that conventional smart trash receptacles are incapable of automatically trash bag fitting in a simple and reliable way, as well as how to address the issue that conventional smart trash receptacles are incapable of detecting the position of a trash bag therein and hence tend to suffer from breakage of the trash bag during automatic bag replacement and how to satisfy the need for information about such intra-receptacle position of the trash bag for further intelligence in smart trash receptacles remain critical technical problems sought to be solved by those skilled in the art.

### SUMMARY

In order to address the above problems to at least some extent, it is an object of the present invention to provide a trash bag fitting device for a smart trash receptacle with the combination of the weakness-free trash bag, problems of non-automatic or complex bag fitting and inconvenience of use witnessed in conventional smart trash receptacles can be overcome.

A trash bag fitting device for a smart trash receptacle, the trash bag fitting device is configured to fit a trash bag into a main body of the trash receptacle and includes a vacuum assembly and a motor for driving the vacuum assembly. The vacuum assembly defines an air inlet and an air outlet. The air inlet communicates with the inside of the main body, with the air outlet being in communication with the outside of the main body of the trash receptacle.

Preferably, the vacuum assembly is a centrifugal impeller type vacuum assembly or an axial-flow fan type vacuum assembly.

Preferably, the centrifugal impeller type vacuum assembly comprises a casing and a centrifugal impeller housed in the casing, wherein the air inlet is defined in the casing so as to axially oppose the centrifugal impeller, with the air outlet therein opposing the centrifugal impeller radially or being tangential thereto, and wherein the air inlet communicates with the air vent in the inner wall of the main body of the trash receptacle, with the air outlet in communication with the outside of the main body.

Preferably, the centrifugal impeller further comprises blades and a wheel to which all the blades are fixed and oriented perpendicular.

Preferably, the blades each provided with, at a portion thereof in positional correspondence with the air inlet, a shoulder projecting toward the air inlet. The shoulder is sheet-like and integral with the blade on which it is provided.

Preferably, the casing comprises a top piece and a bottom piece detachably coupled to the top piece, and the air inlet is defined in the top piece, with gaps between the top piece and the bottom piece providing the air outlet.

Preferably, The top piece is formed as a whole with the main body, the air vent of the main body and the air inlet are combined into one structure so that the air inlet is directly communicates with inside of the main body.

Preferably, the top piece is provided with at least two posts that project from a bottom side thereof and are snugly insertable into respective at least two recesses defined in the bottom piece.

Preferably, the centrifugal impeller is provided with a shaft hole in which a output shaft of the motor is received and secured, and the bottom piece is provided with a hole through which the output shaft is inserted.

Preferably, each of the blades is curved in shape.

Preferably, each of the blades has an end portion away from a center of the wheel that is thinner than its remaining portion.

It is a second object of the present invention to provide a smart trash receptacle comprising the trash bag fitting device as defined in any one of the above paragraphs.

In the trash bag fitting device for a smart trash receptacle provided in the present invention, comprising the vacuum assembly and the motor for driving the vacuum assembly that comprises the air inlet in communication with the air vent in the inner wall of the main body of the trash receptacle and the air outlet in communication with the outside of the main body, the vacuum assembly can evacuate the air from the main body of the trash receptacle through the air vent thereof, reducing the pressure in the main body below the ambient atmospheric pressure. As a result, the weakness-free trash bag is pushed down to the bottom of the receptacle. At this point, the motor can be turned off, with the trash bag having been fitted over internal surfaces of the main body. In this way, problems of non-automatic or complex bag fitting and inconvenience of use witnessed in conventional smart trash receptacles can be overcome.

Preferably, the smart trash receptacle further comprises a trash bag detection device, comprising a transmitter for transmitting a signal and a receiver for receiving a signal, both the transmitter and the receiver being disposed on internal surfaces of the trash receptacle, wherein:

the signal received by the receiver is a direct signal transmitted from the transmitter or a signal from the transmitter that has been reflected.

Preferably, the trash bag detection device may further comprise a control mechanism, wherein each of the transmitter, the receiver and the trash bag fitting device is communicatively coupled to the control mechanism, wherein the control mechanism is configured to control an operational status of the trash bag fitting device based on the signal received by the receiver, and wherein:

i) the signal received by the receiver is a direct signal sent from the transmitter, and in the event of a trash bag being present between the receiver and the transmitter, the receiver produces a first sense signal based on which the control mechanism instructs the trash bag fitting device to stop its operation; or

ii) the signal received by the receiver is a signal from the transmitter that has been reflected, and in the event of a trash bag being present in the receptacle and close to both the receiver and the transmitter, the receiver produces a first sense signal based on which the control mechanism instructs the trash bag fitting device to stop its operation.

Preferably, the transmitter is an infrared (IR) transmitter and the receiver is an IR receiver; or the transmitter is an ultrasonic transmitter and the receiver is an ultrasonic receiver.

According to a preferred embodiment, the signal received by the receiver is a direct signal sent from the transmitter, wherein:

i) the transmitter is disposed on an internal bottom surface of the trash receptacle and the receiver on an internal side surface thereof so that a central transmission axis of the transmitter is oriented at an angle α of 30-50 degrees with respect to the internal bottom surface of the trash receptacle and that a central reception axis of the receiver is oriented at an angle β of 38-58 degrees with respect to a vertical direction for the internal side surface of the trash receptacle; or

ii) the receiver is disposed on the internal bottom surface of the trash receptacle and the transmitter on the internal side surface thereof so that the central reception axis of the receiver is oriented at an angle α of 30-50 degrees with respect to the internal bottom surface of the trash receptacle and that the central transmission axis of the transmitter is oriented at an angle β of 38-58 degrees with respect to the vertical direction for the internal side surface of the trash receptacle.

According to an alternative embodiment, the signal received by the receiver is a direct signal sent from the transmitter; the transmitter and the receiver are disposed in opposition to each other on internal side surfaces of the trash receptacle and are both close to the internal bottom surface of the trash receptacle.

According to another preferred embodiment, the signal received by the receiver is a signal from the transmitter that has been reflected,

i) the transmitter and the receiver are both disposed on the internal bottom surface of the trash receptacle, with the central transmission axis of the transmitter and the central reception axis of the receiver being both directed upward; or

ii) the transmitter and the receiver are both disposed on an internal side surface of the trash receptacle, with the central transmission axis of the transmitter and the central reception axis of the receiver being both directed toward the interior of the receptacle.

Preferably, the transmitter and the receiver are fixed on the internal surfaces of the trash receptacle by means of respective poka-yokes.

According to another preferred embodiment, the trash bag detection device further comprises dustproof, light-shading protective hoods that are attached to the internal surfaces of the trash receptacle and respectively house the transmitter and the receiver.

In a third aspect of the present invention, there is provided a method for control of automatic bag replacement for a smart trash receptacle, the smart trash receptacle comprising the trash bag detection device as defined above, the method comprising the steps of:

activating the trash bag fitting device;

determining whether the receiver produces a first sense signal; and

if so, deactivating the trash bag fitting device.

Preferably, the method further comprises, prior to the activation of the trash bag fitting device:

opening a trash bag removal channel of the trash receptacle and determining whether a first sense signal is produced;

if so, raising an alert; and

if not, closing the trash bag removal channel and activating the trash bag fitting device.

Preferably, the trash bag fitting device may be a centrifugal fan.

The trash receptacle and the method for control of automatic bag replacement for a smart trash receptacle of the present invention enable detection of a trash bag in the trash receptacle, and perform control based on the position information of the trash bag. When the trash bag isn't fitted in place, maintain the trash bag fitting device activating; otherwise, deactivate the trash bag fitting device.

The technical solution provided by the present invention offers the following beneficial effects:

1. By the trash bag fitting device of the present invention, problems of non-automatic or complex bag fitting and inconvenience of use witnessed in conventional smart trash receptacles can be overcome.

2. Compared to conventional trash receptacles, it is capable of sensing the status of the trash bag within the receptacle, thus controlling the actions of the related mechanisms.

3. The “direct” detection approach (in which the receiver receives a direct signal) allows detecting whether a trash bag is present in the trash receptacle, while the “reflected” detection approach (in which the receiver receives a reflected signal) allows precisely determining the position of a trash bag in the trash receptacle based on the strength of the reflected signal so that the signal enables continuous position sensing, making it possible for the control system to make proper decisions in executing various program outputs.

4. The detection device is more resistant to inference from sunlight and will not fail under sunlight conditions.

5. The trash bag fitting device can be deactivated after the trash bag has been fitted in place in order to avoid the trash bag from being sucked into the trash bag fitting device and broken. This is helpful in protecting the trash bag, saving resources, reducing potential safety risks of the smart trash receptacle and increasing its stability and reliability.

### BRIEF DESCRIPTION OF THE DRAWINGS

FIG. 1 is an exploded view of a trash bag fitting device in the smart trash receptacle according to Embodiment 1.

FIG. 2 is a structural schematic of a centrifugal impeller in the trash bag fitting device for the smart trash receptacle according to Embodiment 1.

FIG. 3 is a structural schematic of a trash bag detection device according to Embodiment 2 of the present invention.

FIG. 4 is an enlarged view of a portion of FIG. 3, showing an IR transmitter.

FIG. 5 is an enlarged view of a portion of FIG. 3, showing an IR receiver.

FIG. 6 is a structural schematic of a protective hood in the trash bag detection device according to Embodiment 2.

FIG. 7 is a circuit diagram of the IR receiving circuitry in the trash bag detection device according to Embodiment 2.

FIG. 8 is a flowchart of a method for control of automatic bag replacement for a smart trash receptacle according to Embodiment 2.

FIG. 9 is a structural schematic of a trash bag detection device according to Embodiment 3 of the present invention.

FIG. 10 is a circuit diagram of an IR receiving circuitry in the trash bag detection device according to Embodiment 3.

FIG. 11 is a flowchart of a method for control of automatic bag replacement for a smart trash receptacle according to Embodiment 3.

FIG. 12 is a structural schematic of a transmitter and a receiver in the trash bag detection device, which are both disposed on an internal side surface of the trash receptacle according to Embodiment 3.

FIG. 13 is a structural schematic of a smart trash receptacle with an internal bin and an outer bin in Embodiment 3.

### DETAILED DESCRIPTION

Exemplary embodiments will be described in detail below, examples of which are illustrated in the accompanying drawings. Whenever mentioned in the following description, the same numbers in different figures represent the same or similar elements, unless otherwise stated. The implementations set forth in the following description of exemplary embodiments do not represent all implementations consistent with the claimed invention. Instead, they are merely some examples of devices and methods consistent with certain aspects of the invention as specified in the appended claims.

Embodiments will be described below with reference to the accompanying drawings. In addition, the embodiments set forth below do not limit the invention as defined by the appended claims in any sense. Further, none of the features described in the following embodiments are considered necessarily essential to the subject matter of the claims attached.

### Embodiment 1

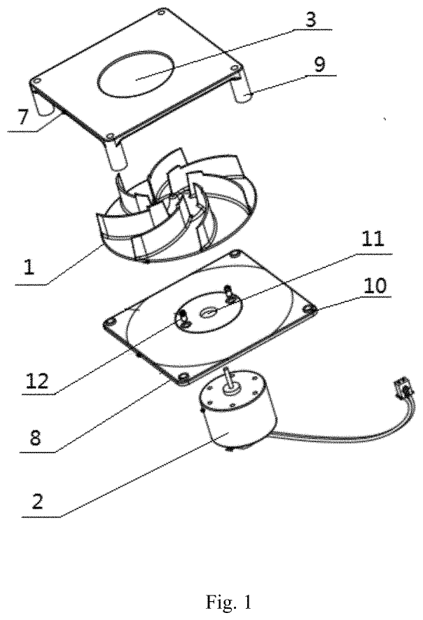

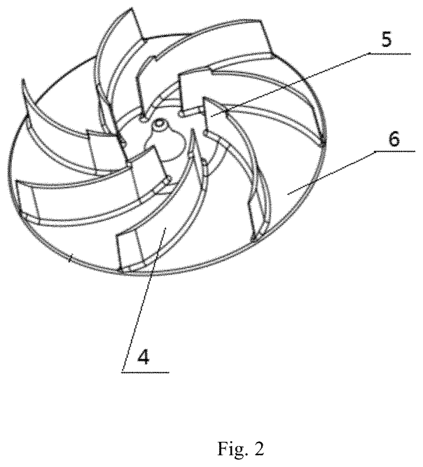

In reference to FIGS. 1 to 2, the trash bag fitting device for a smart trash receptacle provided in the present embodiment is configured to fit a trash bag into a main body of the trash receptacle and includes a vacuum assembly and a motor 2 for driving the vacuum assembly. The vacuum assembly defines an air inlet 3 and an air outlet. The air inlet 3 communicates with an air vent in an inner wall of the main body of the trash receptacle, with the air outlet being in communication with the outside of the main body of the trash receptacle. It operates with the motor 2 driving the vacuum assembly to create a certain degree of vacuum in the main body so that, under the action of atmospheric pressure, the trash bag is uniformly and tightly fitted over internal surfaces of the main body.

It should be noted that the vacuum assembly may be selected as a centrifugal impeller type or axial-flow fan type vacuum assembly or another air pumping assembly capable of air evacuation, depending on the practical need and actual circumstances.

In addition, as shown in FIG. 1, the centrifugal impeller type vacuum assembly may include a casing and a centrifugal impeller 1 housed in the casing. The air inlet 3 is defined in the casing so as to axially oppose the centrifugal impeller 1, while the air outlet is defined therein in so as to radially oppose the centrifugal impeller 1. Moreover, the air inlet 3 communicates with the air vent in the inner wall of the main body and the air outlet with the outside of the main body. When the centrifugal impeller 1 is driven to rotate by the motor 2, air will be evacuated from the main body through the air vent at the bottom thereof so that the ambient atmospheric pressure will be much higher than that in the main body and hence push the trash bag downward. Upon the lower end of the trash bag coining into contact with the bottom of the trash receptacle, the fitting action is completed and motor may then be turned off.

In particular, the centrifugal impeller 1 may have blades 4 each provided with, at a portion thereof in positional correspondence with the air inlet 3, a shoulder 5 projecting toward the air inlet 3. This structure allows an increased wind shear area, air intake and suction power, faster air evacuation, reduced time required for vacuum creation, time savings in trash bag fitting and improved operational efficiency.

It should be noted that the shoulders 5 may be sheet-like and have the same thicknesses as the respective blades 4. For the sake of simplicity in their fabrication process, the shoulders 5 may be integral with the respective blades 4. In this way, a greater wind shear area and easy fabrication can be both achieved.

With this arrangement, the problems of non-automatic or complex bag fitting and inconvenience of use arising from the use of conventional smart trash receptacles can be addressed.

In a preferred example of this embodiment, the centrifugal impeller 1 may further include a wheel 6 to which the individual blades 4 are all fixed. As shown in FIG. 2, the blades 4 may be all oriented perpendicular to the wheel 6. In this example, each of the blades 4 may be curved in shape and have an end portion away from a center of the wheel 6 that is thinner than its remaining portion. This design allows effective airflow control and prompt ventilation.

It should be noted that, in one embodiment, the casing may be comprised of a top piece 7 and a bottom piece 8 detachably coupled to the top piece 7. The air inlet 3 may be defined in the top piece 7, with gaps between the top piece 7 and the bottom piece 8 providing the air outlet.

In this example, both the top piece 7 and the bottom piece 8 may be square structure (e.g. rectangular). In addition, the top piece 7 may be engaged with the bottom piece 8 by snugly inserting at least two posts 9 projecting from a bottom side of the top piece 7 into respective at least two recesses 10 in the bottom piece 8. Specifically, in order to ensure secure engagement, four posts 9 may be provided at the respective corners of the top piece 7.

It should be noted that, in some embodiments, the top piece 7 is formed as a whole with the main body, i.e., the casing has no top piece 7. The air vent of the main body and the air inlet 3 are combined into one so that the air inlet 3 is directly communicates with inside of the main body.

In this way, the casing appears as a four-sided open structure. Additionally, the air inlet 3 may have a circular cross-section. The centrifugal impeller 1 may operate in a centrifugal manner in which air is sucked in through the circular air inlet 3 and fast discharged from the four open sides of the casing. Of course, the casing may be a closed structure. Only one tangential direction of the centrifugal impeller 1 is provided with an air outlet in the casing. In this way, the noise of the centrifugal fan when it is running can be reduced. The air inlet 3 may also assume a different shape.

Further, the centrifugal impeller 1 may be provided with a shaft hole in which a output shaft of the motor 2 is received and secured. Additionally, the bottom piece 8 may be provided with a hole 11 through which the output shaft is inserted. The bottom piece 8 may be first fastened to the motor 2 with screws 12, and the centrifugal impeller 1 may be then secured to the output shaft of the motor 2. Finally, the top piece 7 may be engaged with the bottom piece 8, thus forming the centrifugal fan.

The so formed centrifugal fan can evacuate the air from the main body of the trash receptacle through the air vent thereof, reducing the pressure therein below the ambient atmospheric pressure. As a result, the weakness-free trash bag is pushed down to the bottom of the trash receptacle. At this point, the centrifugal fan may be turned off, with the trash bag having been fitted over the internal surfaces of the main body. Therefore, the fitting of the trash bag does not require human intervention, allowing convenience and ease of use.

In one embodiment, there is also provided a smart trash receptacle incorporating the trash bag fitting device as defined above. In this way, problems of non-automatic or complex bag fitting and inconvenience of use witnessed in conventional smart trash receptacles can be overcome.

It should be noted that the terms “top” and “bottom” are referred to herein with respect to the configuration of the trash bag fitting device as shown in FIG. 1.

### Embodiment 2

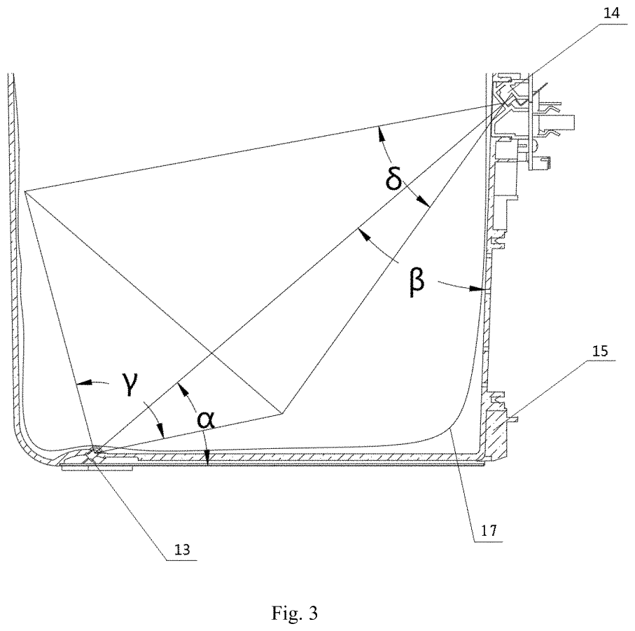

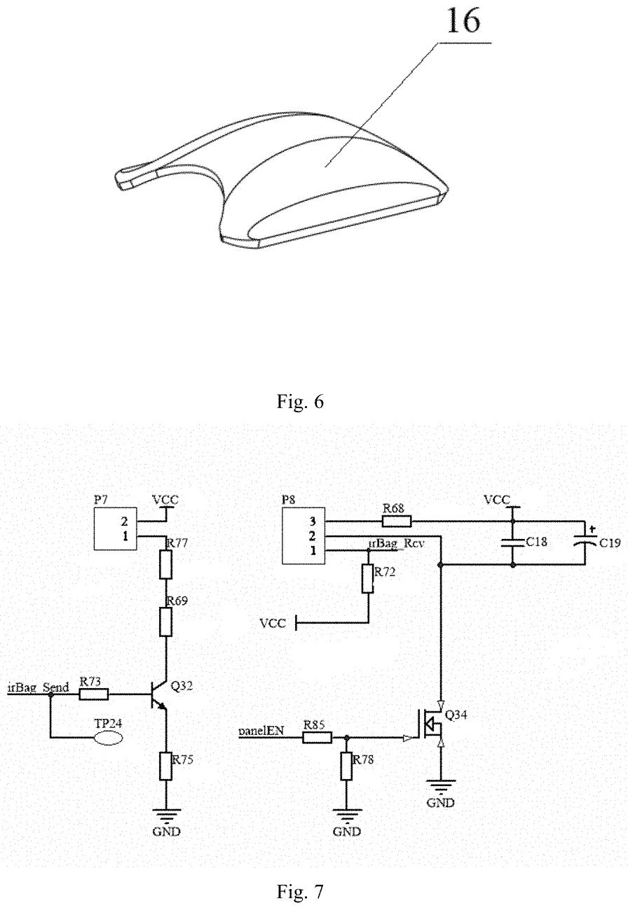

In reference to FIGS. 3 to 8, the smart trash receptacle in the present embodiment further includes a trash bag detection device.

The trash bag detection device includes a transmitter 13 capable of transmitting a signal and a receiver 14 capable of receiving a signal. The transmitter 13 and the receiver 14 are disposed in opposition to each other on internal surfaces of the trash receptacle so that the receiver 14 can receive a direct signal transmitted from the transmitter 13. In this way, when a trash bag 17 is partially present between the transmitter 13 and the receiver 14, the signal from the transmitter 13 will be blocked by the trash bag 17. In response, the receiver 14 will generate a first sense signal, thereby enabling detection of the position of the trash bag 17 in the trash receptacle.

In this embodiment, the transmitter 13 and the receiver 14 may both be infrared (IR) devices, i.e., an IR transmitter and an IR receiver, respectively. However, the present invention is not so limited, because they may also be ultrasonic transmitting and receiving devices or other radar-like radio transmitting and receiving devices, without departing from the scope of the invention.

As infrared rays are electromagnetic waves whose wavelengths are between the microwave and visible light, it is highly stable and penetrative in nature. Moreover, the IR transmitter and the IR receiver are not expensive and helpful in saving cost. In addition, by this transmit-receive approach, the detection device is more resistant to inference from sunlight and can avoid failure of the transmitter and receiver when they are operating under sunlight conditions. For these reasons, the transmitter 13 and the receiver 14 are preferably implemented as an IR transmitter and an IR receiver, respectively, and the following description is given in the context of an IR transmitter and an IR receiver as an example.

In such an arrangement, the IR detection devices allow simple and reliable detection of the position of the trash bag 17 in the trash receptacle, which is a piece of information necessary for further intelligence of the smart trash receptacle. Using such a position detection device with the smart trash receptacle is helpful in improving its automatic trash bag fitting quality and augmenting intelligence in its performance.

According to the present invention, the trash bag detection device may further include a control mechanism. The IR transmitter 13 and the IR receiver 14 may be communicatively coupled to the control mechanism. Under the action of the control mechanism, the IR transmitter 13 is capable of transmitting a signal and the IR receiver 14 is capable of receiving the signal from the IR transmitter 13. In this way, when a trash bag 17 is partially present between the IR transmitter 13 and the IR receiver 14, the signal from the IR transmitter 13 will be blocked by the trash bag 17. In response, the IR receiver 14 will generate a first sense signal and transmit the first sense signal to the control mechanism, based on which, operational statuses of the components involved in automatic bag replacement can be controlled.

In this embodiment, the trash bag fitting device used for evacuating the air from the trash receptacle through an air vent may be a centrifugal fan 15. The centrifugal fan 15 is communicatively coupled to the control mechanism. When the control mechanism received the first sense signal from the IR receiver 14, the control mechanism may perform control to deactivate the fan 15.

The fan 15 is configured to evacuate the air from the trash receptacle through an air vent. As a result, the trash bag 17 is pushed and automatically fitted into the trash receptacle by the ambient atmospheric pressure. Each of the fan 15, the IR transmitter 13 and the IR receiver 14 may be communicably coupled to the control mechanism, and the first sense signal may be transmitted to the control mechanism, based on which, operational statuses of the fan 15 and other components involved in automatic bag replacement can be controlled.

In this way, during trash bag replacement, the smart trash receptacle is not only capable of detecting the position of the trash bag 17 in the trash receptacle, but can deactivate the fan 15 after the trash bag 17 has been fitted in place in order to avoid it from being sucked into the fan 15 and broken. Thus, the trash bag detection device is helpful in protecting the trash bag 17, saving resources, reducing potential safety risks of the smart trash receptacle and increasing its stability and reliability.

In some embodiments, one of the IR transmitter 13 and IR receiver 14 may be provided on an internal side surface of the trash receptacle and the other on an internal bottom surface thereof. That is, it is either possible that the IR transmitter 13 is disposed on the internal side surface of the trash receptacle and the IR receiver 14 on the internal bottom surface thereof, or that the IR transmitter 13 is disposed on the internal bottom surface and the IR receiver 14 on the internal side surface, and this may be determined based on the actual circumstances.

Additionally, the fan 15 may be provided at the junction of the internal side surface and internal bottom surface of the trash receptacle. In this way, the air being evacuated from the air vent will always traverse between the IR transmitter 13 and the IR receiver 14. In the trash bag fitting process proceeding under the action of air evacuation by the fan 15, any part of the trash bag 17 will not be situated between the IR transmitter 13 and the IR receiver 14 prior to the completion of the fitting process, and accordingly, the IR receiver 14 will not produce the first sense signal. Subsequent to the completion of the trash bag fitting process, the trash bag 17 will be present between the IR transmitter 13 and the IR receiver 14, triggering generation of the first sense signal by the IR receiver 14 and further deactivation of the fan 15 by the control mechanism based on the received first sense signal.

Further, in the case of the IR transmitter 13 on the internal bottom surface of the trash receptacle and of the IR receiver 14 on the internal side surface thereof, a central transmission axis of the IR transmitter 13 may be oriented at an angle α of 30-50 degrees with respect to the internal bottom surface of the trash receptacle, with a central reception axis of the IR receiver 14 being oriented at an angle β of 38-58 degrees with respect to a vertical direction for the internal side surface of the trash receptacle. As shown in FIG. 3, the vertical direction for the internal side surface is the direction perpendicular to the bottom surface of the trash receptacle. As any reduction in the angle α will increase the possibility of sensing errors that may cause negative effects on the positional detection for the trash bag 17, and since any increase in the angle α will require the IR receiver 14 to be disposed more distant, which is unfavorable to both the detection and the assembly. This arrangement allows cost savings, easy assembly and higher detection accuracy.

In the case of the IR receiver 14 on the internal bottom surface of the trash receptacle and of the IR transmitter 13 on the internal side surface thereof, the central reception axis of the IR receiver 14 may be oriented at an angle α of 30-50 degrees with respect to the internal bottom surface of the trash receptacle, with the central transmission axis of the IR transmitter 13 being oriented at an angle β of 38-58 degrees with respect to the vertical direction for the internal side surface of the trash receptacle. As any reduction in the angle α will increase the possibility of sensing errors that may cause negative effort on the positional detection for the trash bag, and since any increase in the angle α will require the IR transmitter 13 to be disposed more distant, which is unfavorable to both the detection and the assembly, this arrangement allows cost savings, easy assembly and higher detection accuracy.

In a preferred example of this embodiment, the angle α is 40 degrees and the angle β is 48 degrees. In this way, the distance between the detectors is moderate and good detection results can be obtained, resulting in cost savings and easy assembly.

In addition, the IR transmitter 13 may be configured to transmit infrared rays at a maximum angle γ of 93 degrees, and the IR receiver 14 may be configured to receive infrared rays at a maximum angle δ of 44 degrees, as shown in FIG. 3. In this way, both the transmission and reception can be performed in a wide angle range, which is conducive to the accuracy of positional detection for the trash bag.

In another embodiment, IR receiver 14 and the IR transmitter 13 may be disposed on respective internal side surfaces of the trash receptacle in such a manner that they are close to the internal bottom surface thereof on which the fan 15 is provided. With this arrangement, the air being evacuated from the air vent will always traverse between the IR transmitter 13 and the IR receiver 14. In the trash bag fitting process proceeding under the action of air evacuation by the fan 15, any part of the trash bag 17 will not be situated between the IR transmitter 13 and the IR receiver 14 prior to the completion of the fitting process, and accordingly, the IR receiver 14 will not produce the first sense signal. Subsequent to the completion of the trash bag fitting process, the trash bag 17 will be present between the IR transmitter 13 and the IR receiver 14, triggering generation of the first sense signal by the IR receiver 14 and deactivation of the fan 15 by the control mechanism based on the received first sense signal.

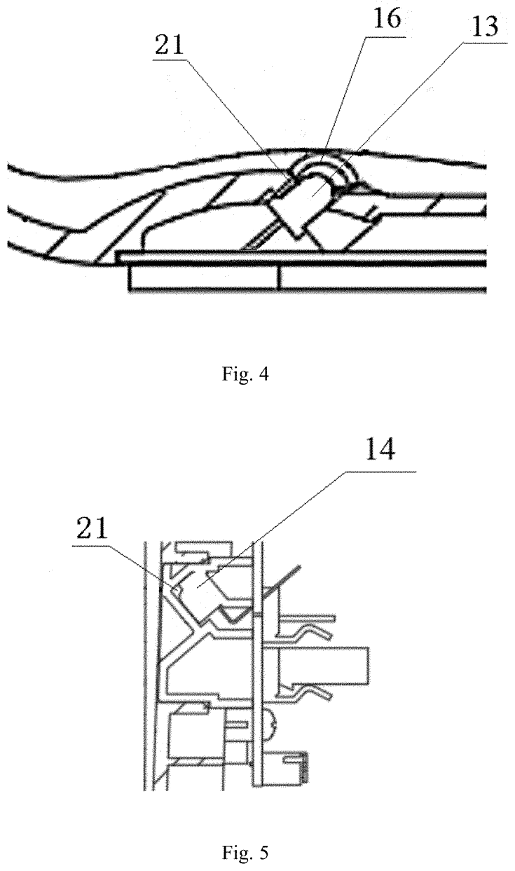

As shown in FIGS. 4 to 5, the IR transmitter 13 and IR receiver 14 may be structurally fixed in terms of both position and angle so as to ensure that the IR transmitter 13 transmits the signal directly toward the IR receiver 14. Moreover, the IR transmitter 13 and IR receiver 14 may be structured to limit the angle of transmission so as to avoid the IR signal from propagating through the gap between the trash bag 17 and the bottom of the trash receptacle to reach the IR receiver 14. In other words, the IR transmitter 13 and IR receiver 14 may be both fixed at desired orientation angles on the internal surfaces of the trash receptacle by poka-yokes known in the art which ensure their positional and angular correctness. The use of such poka-yokes can result in savings in time and labor as well as an improvement in efficiency.

Further, each of the poka-yokes may be comprised of a concave member and a convex member that can be snugly received in the concave member. Additionally, on the internal surfaces of the trash receptacle, cavities 21 that can snugly receive the IR transmitter 13 and the IR receiver 14 and are oriented to limit their aforesaid angles may be formed. One of the concave and convex members may be disposed over an outer surface of the IR receiver 14 or the IR transmitter 13 and the other over an inner surface of a respective one of the cavities. The concave member may extend axially. For example, in the case of the convex member disposed over the outer surface of the IR receiver 14 or the IR transmitter 13 and of the concave member over the inner surface of the respective cavity, the term “axially” is meant to refer to a direction in which the cavity extends. In this way, with the poka-yokes each constructed from such concave and convex members, the IR transmitter 13 and the IR receiver 14 can be both fixed at desired orientation angles with guaranteed positional and angular correctness. As a result, savings in time and labor and improved efficiency can be achieved.

In some embodiments, the IR transmitter 13 and the IR receiver 14 may both be made waterproof and dustproof by means of transparent protective hoods 16 hermetically attached to the internal surfaces of the trash receptacle. Although the IR transmitter 13 and the IR receiver 14 are housed in the protective hoods 16, positional detection for the trash bag is still possible since the transparent nature of these protective hoods 16 allows the transmission of infrared ray therethrough. The protective hoods 16 may be structured as shown in FIG. 4 and made of either plastic or glass, depending on the actual circumstances.

The control mechanism may include a microcontroller unit (MCU) as well as IR Tx/Rx circuitry composed of an amplification circuit, a modulator/demodulator (modem) circuit and the like. As shown in FIG. 7, the MCU may be configured to produce a modulated carrier signal at 38 KHz and provide it to the IR transmitter 13 (As the “irBag Send” shown in FIG. 7). If the carrier signal from the IR transmitter 13 is not obstructed by an obstacle (trash bag 17), it can be successfully received by the IR receiver 14 (As the“irBag Rcv” shown in FIG. 7). When obstructed midway by an obstacle (trash bag 17), the carrier signal from the IR transmitter 13 will no longer smoothly reach the IR receiver 14. As a result, the modulated carrier signal arriving at the IR receiver 14 will be very weak or even will not be received at all. In this way, positional detection for the trash bag is made possible.

The carrier signal received at the IR receiver 14 may further undergo gain amplification and demodulation before it is processed and then sent to a comparator. The comparator then generates a first sense signal as an output. This imparts very strong interference resistance to the detection, making it normally performable under harsh lighting conditions and under sunlight. The IR transmitter 13 may be configured to transmit the signal at a power level that is so limited to disallow the signal to transmit through the trash bag to arrive at the IR receiver 14. Upon unsuccessfully receipt of the IR signal at the IR receiver 14, the presence of the trash bag can be confirmed and the fan 15 can be instructed to cease its operation.

By this way, the trash bag detection device enables detecting the position of a trash bag 17 in the trash receptacle and performing control of the fan based on the detection information about the trash bag 17 so that when the trash bag 17 isn't fitted in place, keep the fan running; otherwise, deactivate the centrifugal fan so as to avoid the trash bag 17 being sucked into the centrifugal fan and damage the trash bag 17.

This is helpful in protecting the trash bag 17, saving resources, reducing potential safety risks of the smart trash receptacle and increasing the stability and reliability of the trash receptacle.

The smart trash receptacle in this embodiment includes the trash bag detection device as defined in EMBODIMENT 2.

In doing so, during trash bag replacement for the smart trash receptacle, the trash bag detection device is not only capable of detecting the position of the trash bag 17 in the trash receptacle, but can perform control based on the detected information about the position of the trash bag 17, so that the fitting process is kept running and ceased respectively before and after the trash bag 17 has been fitted in place while avoiding the trash bag 17 from being sucked into the fan 15 and broken. Thus, the trash bag detection device is helpful in protecting the trash bag, saving resources, reducing potential safety risks of the smart trash receptacle and increasing its stability and reliability.

In a particular embodiment, there is also provided a method for control of automatic bag replacement for the smart trash receptacle as defined above. The method includes:

activating the fan 15;

determining whether the IR receiver produces a first sense signal;

if so, deactivating the fan 15.

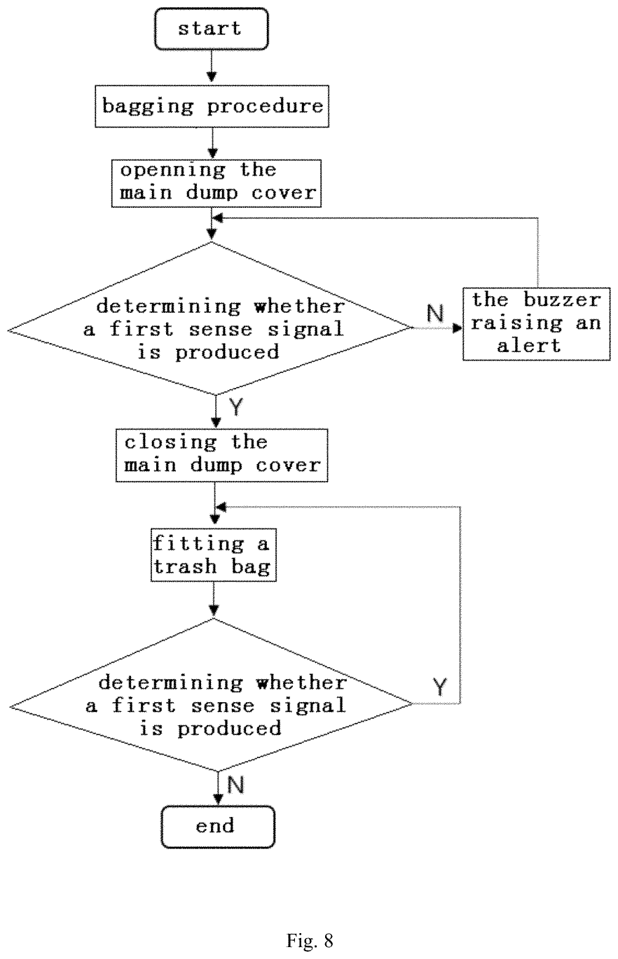

Further, prior to the activation of the fan 15, detection may be performed to find whether there is bagged trash within the trash receptacle. This can avoid the degradation in positional detection accuracy during subsequent trash bag fitting due to the bagged trash remaining in the receptacle. FIG. 8 is a flowchart illustrating a detailed process of the method, including:

opening a main dump cover 19 of the trash receptacle and then determining whether a first sense signal is produced;

if so, raising an alert;

if not, closing the main dump cover 19 and activating the fan 15;

determining whether the IR receiver produces a first sense signal;

if so, deactivating the fan 15.

It should be noted that, in the present embodiment, the opening and closing of the main dump cover 19 can realize the opening and closing of a trash bag removal channel. When the bagging process has finished, open the main dump cover 19 to allow the bagged trash to be taken out; When the system detects that the bagged trash has been taken out, close the main dump cover 19 again so as to carry on the procedure of fitting a new trash bag. The “alert” may be given by a buzzer to prompt the operator to take the bagged trash away so as to avoid it from remaining within the smart trash receptacle.

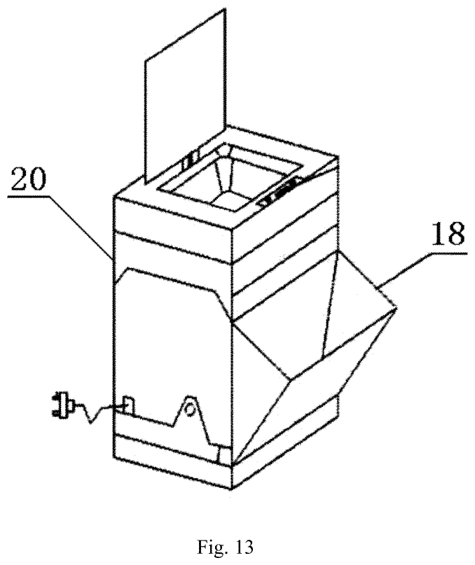

Of course, the smart trash receptacle may also take on other forms of prior art, as shown in FIG. 13, the smart trash receptacle may have an outer bin 20 with a trash bag removal channel and an internal bin 18 for storing trash bags. When the bagging process has been finished, the internal bin 18 may then tip to allow the bagged trash to be taken out. After the system senses that the bagged trash has been taken out, restoration of the internal bin 18 so as to carry on the procedure of fitting a new trash bag.

### Embodiment 3

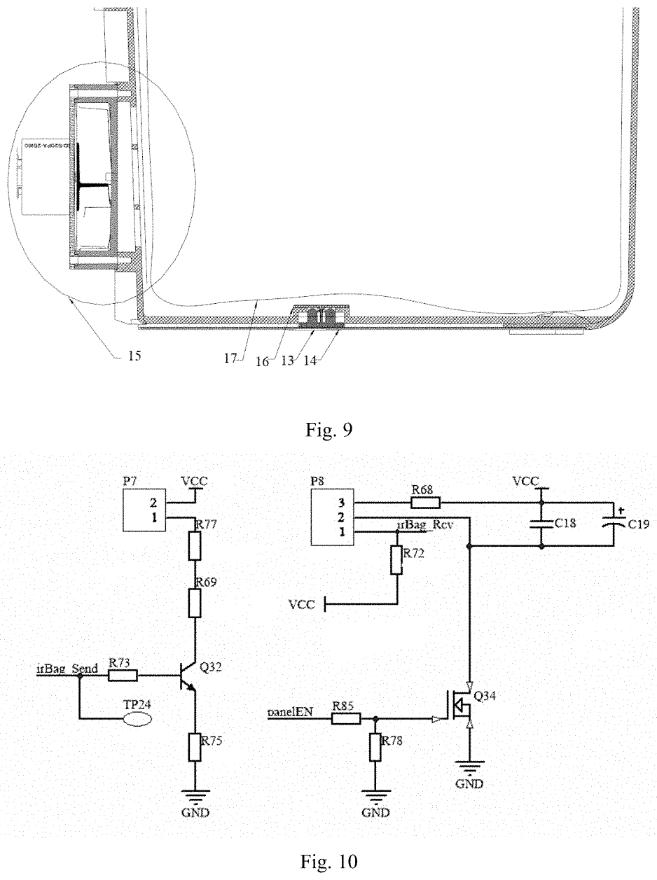

Reference is now made to FIGS. 9 to 11, in which a trash bag detection device for a smart trash receptacle according to Embodiment 3 of the present invention is shown. For the sake of easy understanding, the same components in this embodiment are indicated by the same reference numbers as Embodiment 2.

As shown in FIGS. 9 to 11, the trash bag detection device according to this embodiment includes a transmitter 13 and a receiver 14. The transmitter 13 is able to transmit a signal which can be reflected at a trash bag 17 or another object so that the reflected part of it is received as a reflected signal by the receiver 14. Moreover, both of the receiver 14 and the transmitter 13 are disposed on an internal surface of the trash receptacle. When the trash bag 17 is approaching downward while being fitted, the reflected signal will become increasingly stronger as the distance from the detectors to the trash bag 17 is being shortened. As a result of the increasingly stronger reflected signal received by the receiver 14, the position of the trash bag 17 in the trash receptacle can be precisely perceived.

The aforementioned internal surface may either be an internal side surface of the trash receptacle or an internal bottom surface thereof. The transmitter 13 and the receiver 14 are not limited to any particular positional layout as long as they are not directed toward each other to allow the signal from the transmitter 13 to be reflected at the approaching trash bag 17 or another approaching object so that part of it is received by the receiver 14 as a reflected signal.

According to the present invention, the trash bag detection device may further include a control mechanism. The IR transmitter 13 and the IR receiver 14 may be communicatively coupled to the control mechanism. Under the action of the control mechanism, the transmitter 13 is capable of transmitting a signal and the receiver 14 is capable of receiving the signal from the transmitter 13. In this way, when a trash bag 17 is partially present between the transmitter 13 and the receiver 14, the signal from the transmitter 13 will be blocked by the trash bag 17. In response, the receiver 14 will generate a first sense signal and transmit the first sense signal to the control mechanism, based on which, operational statuses of the components involved in automatic bag replacement can be controlled.

In this embodiment, the trash bag fitting device used for evacuating the air from the trash receptacle through an air vent may be a centrifugal fan 15. The centrifugal fan 15 is communicatively coupled to the control mechanism. When the control mechanism received the first sense signal from the receiver 14, the control mechanism may perform control to deactivate the fan 15.

The fan is configured to evacuate the air from the trash receptacle through an air vent. As a result, the trash bag is pushed and automatically fitted into the trash receptacle by the ambient atmospheric pressure. Each of the fan 15, the IR transmitter 13 and the IR receiver 14 may be communicably coupled to the control mechanism, and the first sense signal may be transmitted to the control mechanism, based on which, operational statuses of the fan 15 and other components involved in automatic bag replacement can be controlled.

In the way, during trash bag replacement for the smart trash receptacle, the trash bag detection device is not only capable of detecting the position of the trash bag 17 in the trash receptacle, but can perform control based on the detected information about the position of the trash bag 17, so that the fitting process is kept running and ceased respectively before and after the trash bag 17 has been fitted in place while avoiding the trash bag 17 from being sucked into the fan 15 and broken. Thus, the trash bag detection device is helpful in protecting the trash bag, saving resources, reducing potential safety risks of the smart trash receptacle and increasing its stability and reliability.

With similarity to EMBODIMENT 2, in this embodiment, the transmitter 13 is preferably implemented as an infrared (IR) transmitter and the receiver 14 accordingly as an IR receiver. In other words, an IR signal is transmitted, reflected and partially received.

In such an arrangement, the process carried out by the IR devices, involving transmission, reflection and reception, allows simple and reliable detection of the position of the trash bag 17 in the trash receptacle and effective prevention of partial breakage of the trash bag 17 during the automatic bag replacement process. In addition, the position of the trash bag 17 is a piece of information necessary for further intelligence of the smart trash receptacle. Using such a position detection device with the smart trash receptacle is helpful in improving the receptacle's quality in automatic fitting of the trash bag 17 and augmenting intelligence in its performance.

In some embodiments, the transmitter 13 and the receiver 14 are both disposed on the internal bottom surface of the trash receptacle. In this case, the trash bag 17 will gradually approach, from the top downward, the internal bottom surface of the trash receptacle while it is being fitted. As a result, with the trash bag 17 getting increasingly closer, a greater and greater part of the signal will be reflected and the reflected signal received by the receiver 14 will become stronger and stronger, allowing precise perception of the position of the trash bag 17. Further, both a central transmission axis of the transmitter 13 and a central reception axis of the receiver 14 may be directed upward. Here, the terms “upward” and “downward” are referred to with respect to the configuration of the device as shown in FIG. 9. With this design, a signal path for transmission, reflection and reception can be shortened. Moreover, transmission along the central transmission axis imparts high strength to the transmitted signal, and reception along the central reception axis allows good signal reception performance. In this way, both a shorter sensing distance and higher signal strength can be achieved, which is conducive to the device's accuracy and promptness.

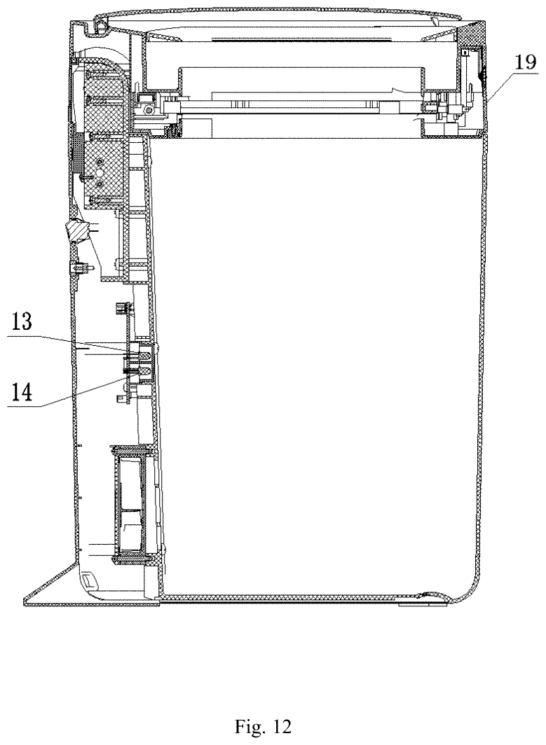

In some embodiments, shown in FIG. 12, the transmitter 13 and the receiver 14 are both disposed on the internal side surface of the trash receptacle, with their central transmission and reception axis pointing toward the interior of the receptacle.

Similarly, the transmitter 13 and receiver 14 may also be structurally fixed in terms of both position and angle so as to prevent un-reflected signal being transmitted to the receiver 14. Specifically, the transmitter 13 and receiver 14 may be both fixed at desired orientation angles on the internal surface of the trash receptacle by poka-yokes known in the art which ensure their positional and angular correctness. The use of such poka-yokes allows one-time fixation in flexible relative positional and angular relationships, resulting in savings in time and labor as well as an improvement in efficiency.

In some embodiments, the transmitter 13 and the receiver 14 may both be made waterproof and dustproof by means of transparent protective hoods 16 hermetically attached to the internal surface of the trash receptacle. Although the transmitter 13 and the receiver 14 are housed in the protective hoods 16, positional detection for the trash bag 17 is still possible since the transparent nature of these protective hoods 16 allows the transmission of the signal therethrough. Of course, one protective hood 16 may be provided for the transmitter 13 and the receiver 14 together, in order for material savings and lower cost to be achieved. The protective hoods 16 may be structured as shown in FIG. 4, and made of either plastic or glass, depending on the actual circumstances.

The control mechanism may include a microcontroller unit (MCU) as well as IR Tx/Rx circuitry composed of an amplification circuit, a modulator/demodulator (modem) circuit and the like. As shown in FIG. 10, the MCU may be configured to produce a modulated carrier signal at 38 KHz and provide it to the transmitter 13 (As the“irBag Send” shown in FIG. 10). If the carrier signal from the IR transmitter 13 is not reflected by an obstacle (trash bag 17), it will not reach the receiver 14 (As the“irBag Rcv” shown in FIG. 10). Otherwise, when the carrier signal from the IR transmitter 13 is reflected by an obstacle (trash bag 17), it will be partially received by the receiver 14, and the position of the trash bag 17 can be known by analyzing the strength of the received signal. The carrier signal received at the receiver 14 may further undergo gain amplification and demodulation before it is processed and then sent to a comparator. The comparator then generates a first sense signal as an output. This imparts very strong interference resistance to the detection, making it normally performable under harsh lighting conditions and under sunlight. The transmitter 13 may be configured to transmit the signal at a power level that is so limited to allow the receiver to successfully receive the reflected signal. Based on the received reflected signal, the position of the receptacle trash bag 17 can be determined and serve as a basis for controlling the operational status of the fan 15.

In this particular embodiment, there is also provided a smart trash receptacle including the trash bag detection device as defined above. In doing so, during replacement of the trash bag 17 for the smart trash receptacle, the trash bag detection device is not only capable of detecting the position of the trash bag 17 in the trash receptacle, but can deactivate the fan 15 after the trash bag 17 has been fitted in place in order to avoid it from being sucked into the fan 15 and broken. Thus, the trash bag detection device is helpful in protecting the trash bag 17, saving resources, reducing potential safety risks of the smart trash receptacle and increasing its stability and reliability. Since the smart trash receptacle offers the substantially same beneficial effects as the above-described trash bag detection device, it will not be described in further detail herein for the sake of simplicity.

In a particular embodiment, there is also provided a method for control of automatic bag replacement for the smart trash receptacle as defined above. The method includes:

activating the fan 15;

determining whether the intensity of a reflected signal received by the receiver 14 reaches the preset value; and

if so, deactivating the fan 15.

Specifically, if the intensity of a reflected signal received by the receiver 14 reaches the preset value, the receiver 14 may produce a first sense signal, the control mechanism performs control to deactivate the fan 15.

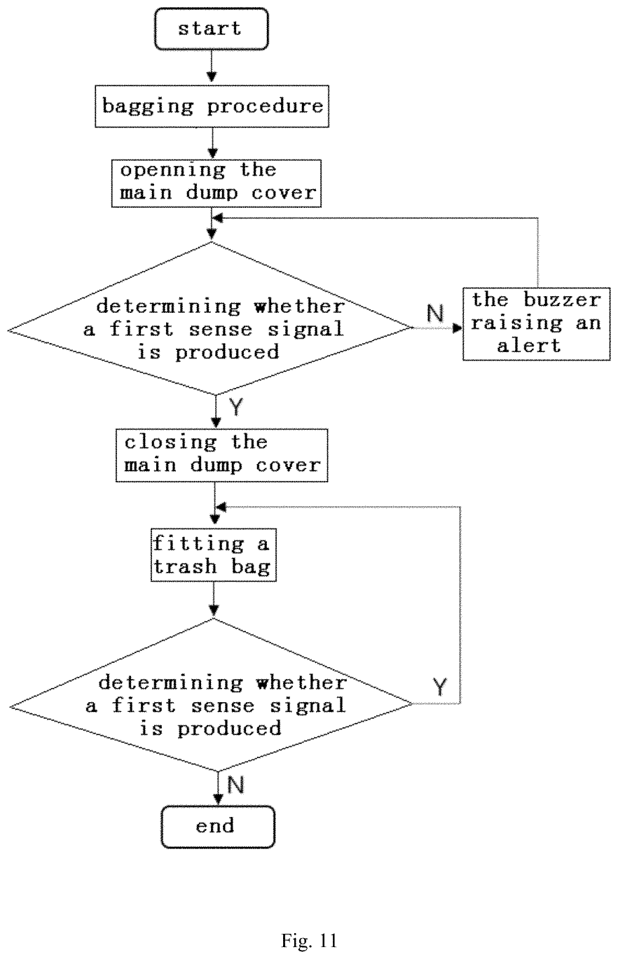

Further, prior to the activation of the fan 15, detection may be performed to find whether there is bagged trash within the trash receptacle. This can avoid the degradation in positional detection accuracy during subsequent trash bag fitting due to the bagged trash remaining in the receptacle. FIG. 11 is a flowchart illustrating a detailed process of the method, including:

opening a main dump cover of the trash receptacle and then determining whether the intensity of the reflected signal received by the receiver 14 reaches the preset value;

if so, raising an alert;

if not, closing the main dump cover and activating the fan 15;

determining whether the intensity of the reflected signal received by the receiver 14 reaches the preset value;

if so, deactivating the fan 15.

It should be noted that, in the present embodiment, the opening and closing of the main dump cover 19 can realize the opening and closing of a trash bag removal channel as shown in FIG. 12. When the bagging process has finished, open the main dump cover to allow the bagged trash to be taken out. When the system detects that the bagged trash has been taken out, close the main dump cover 19 again so as to carry on the procedure of fitting a new trash bag. The “alert” may be given by a buzzer to prompt the operator to take the bagged trash away so as to avoid it from remaining within the smart trash receptacle.

Of course, the smart trash receptacle may also take on other forms of prior art, as shown in FIG. 13, the smart trash receptacle may have an outer bin 20 with a trash bag removal channel and an internal bin 18 for storing trash bags. When the bagging process has been finished, the internal bin 18 may then tip to allow the bagged trash to be taken out. After the system senses that the bagged trash has been taken out, restoration of the internal bin 18 so as to carry on the procedure of fitting a new trash bag.

The foregoing description merely presents a few particular embodiments of the present invention and does not limit the scope thereof in any sense. Any and all variations or substitutions easily devisable by those familiar with the art in light of the teachings disclosed herein are considered to fall within the scope of the present invention. Accordingly, the scope of the invention shall be as defined in the appended claims.

1. A trash bag fitting device for a smart trash receptacle, the trash bag fitting device is configured to fit a trash bag into a main body of the smart trash receptacle, wherein, the trash bag fitting device comprising:
a vacuum assembly and a motor for driving the vacuum assembly, the vacuum assembly comprising an air inlet and an air outlet, the air inlet is in communication with an inner wall of the main body of the trash receptacle, the air outlet is in communication with an outer wall of the main body of the trash receptacle.

2. The trash bag fitting device of claim 1, wherein the vacuum assembly is a centrifugal impeller type vacuum assembly or an axial-flow fan type vacuum assembly.

3. The trash bag fitting device of claim 2, wherein the centrifugal impeller type vacuum assembly comprises a casing and a centrifugal impeller housed in the casing, wherein the air inlet is defined in the casing so as to axially oppose the centrifugal impeller and the air outlet in the casing so as to be radially oppose the centrifugal impeller or tangential thereto, and wherein the air inlet communicates with an air vent in the inner wall of the main body, with the air outlet in communication with the outer wall of the main body of the trash receptacle.

4. The trash bag fitting device of claim 3, wherein the centrifugal impeller further comprises blades and a wheel to which all the blades are fixed and oriented perpendicular.

5. The trash bag fitting device of claim 3, wherein the centrifugal impeller comprises blades each provided with, at a portion thereof in positional correspondence with the air inlet, a shoulder projecting toward the air inlet; and the shoulder is sheet-like and integral with the corresponding blade.

6. The trash bag fitting device of claim 3, wherein the casing comprises a top piece and a bottom piece detachably coupled to the top piece, and wherein the air inlet is defined in the top piece, with gaps between the top piece and the bottom piece defining the air outlet.

7. The trash bag fitting device of claim 6, wherein the centrifugal impeller is provided with a shaft hole in which an output shaft of the motor is received and secured, and wherein the bottom piece is provided with a hole through which the output shaft of the motor is inserted.

8. A smart trash receptacle, comprising a trash bag fitting device configured to fit a trash bag into a main body of the smart trash receptacle, wherein, the trash bag fitting device comprising:
a vacuum assembly and a motor for driving the vacuum assembly, the vacuum assembly comprising an air inlet and an air outlet, the air inlet is in communication with an inner wall of the main body of the trash receptacle, the air outlet is in communication with an outer wall of the main body of the trash receptacle.

9. The smart trash receptacle of claim 8, further comprising a trash bag detection device, the trash bag detection device comprising a transmitter for transmitting a signal and a receiver for receiving a signal, both the transmitter and the receiver being disposed on internal surfaces of the smart trash receptacle, wherein:
the signal received by the receiver is a direct signal transmitted from the transmitter or a signal from the transmitter that has been reflected.

10. The smart trash receptacle of claim 9, wherein the trash bag detection device further comprises a control mechanism; each of the transmitter, the receiver and the trash bag fitting device is communicatively coupled to the control mechanism; the control mechanism is configured to control an operational status of the trash bag fitting device based on the signal received by the receiver, and wherein:
i) when the signal received by the receiver is a direct signal sent from the transmitter, and in an event of a trash bag being present between the receiver and the transmitter, the receiver produces a first sense signal based on which the control mechanism instructs the trash bag fitting device to stop its operation; or
ii) when the signal received by the receiver is a signal from the transmitter that has been reflected, and in an event of a trash bag being present in the receptacle and close to both the receiver and the transmitter, the receiver produces a first sense signal based on which the control mechanism instructs the trash bag fitting device to stop its operation.

11. The smart trash receptacle of claim 9, wherein:
the transmitter is an infrared (IR) transmitter and the receiver is an IR receiver; or
the transmitter is an ultrasonic transmitter and the receiver is an ultrasonic receiver.

12. The smart trash receptacle of claim 10, wherein the signal received by the receiver is a direct signal sent from the transmitter, and wherein:
i) the transmitter is disposed on an internal bottom surface of the trash receptacle and the receiver on an internal side surface thereof so that a central transmission axis of the transmitter is oriented at an angle α of 30-50 degrees with respect to the internal bottom surface of the trash receptacle and that a central reception axis of the receiver is oriented at an angle β of 38-58 degrees with respect to a vertical direction for the internal side surface of the trash receptacle; or
ii) the receiver is disposed on the internal bottom surface of the trash receptacle and the transmitter on the internal side surface thereof so that the central reception axis of the receiver is oriented at an angle α of 30-50 degrees with respect to the internal bottom surface of the trash receptacle and that the central transmission axis of the transmitter is oriented at an angle β of 38-58 degrees with respect to the vertical direction for the internal side surface of the trash receptacle.

13. The smart trash receptacle of claim 10, wherein the signal received by the receiver is a direct signal sent from the transmitter, and wherein:
the transmitter and the receiver are disposed in opposition to each other on internal side surfaces of the trash receptacle and are both close to the internal bottom surface of the trash receptacle.

14. The smart trash receptacle of claim 10, wherein the signal received by the receiver is a signal from the transmitter that has been reflected, and wherein:
i) the transmitter and the receiver are both disposed on the internal bottom surface of the trash receptacle, with a central transmission axis of the transmitter and a central reception axis of the receiver being both directed upward; or
ii) the transmitter and the receiver are both disposed on an internal side surface of the trash receptacle, with the central transmission axis of the transmitter and the central reception axis of the receiver being both directed toward the interior of the receptacle.

15. A method for control of automatic bag replacement for a smart trash receptacle, the smart trash receptacle comprising a trash bag fitting device configured to fit a trash bag into a main body of the smart trash receptacle and a trash bag detection device; wherein the trash bag fitting device comprising a vacuum assembly and a motor for driving the vacuum assembly, the vacuum assembly comprising an air inlet and an air outlet, the air inlet is in communication with an inner wall of the main body of the trash receptacle, the air outlet is in communication with an outer wall of the main body of the trash receptacle; the trash bag detection device comprising a transmitter for transmitting a signal and a receiver for receiving a signal, both the transmitter and the receiver being disposed on internal surfaces of the smart trash receptacle, wherein the signal received by the receiver is a direct signal transmitted from the transmitter or a signal from the transmitter that has been reflected; the method comprising the steps of:
activating the trash bag fitting device;
determining whether the receiver produces a first sense signal; and
if so, deactivating the trash bag fitting device.
